(19) United States
(12) Patent Application Publication
(10) Pub. No.: US 2015/0140170 A1
(43) Pub. Date: May 21, 2015

(54) ACIDIFIED MILK PRODUCT

(71) Applicant: DMK Deutsches Milchkontor GmbH, Zeven (DE)

(72) Inventors: Katja Borcherding, Zeven (DE); Matthias Hoch, Zeven (DE); Ralf Bärwinkel, Brake (DE)

(21) Appl. No.: 14/541,727

(22) Filed: Nov. 14, 2014

(30) Foreign Application Priority Data
Nov. 17, 2013 (EP) 13 193 225.3

(51) Int. Cl. A23C 9/123; A23L 1/39; A21D 15/02; A23C 9/13

(52) U.S. Cl. CPC A23C 9/123; A23C 9/1307; A23L 1/39; A21D 15/02; A23V 2002/00
USPC 426/43; 426/61

(57) ABSTRACT

An acidified milk product is proposed, comprising
(a) 30 to 80 wt % milk,
(b) 5 to 80 wt % fat component,
(c) 0.5 to 4 wt % starch and
(d) 0.001 to 0.1 wt % of mesophilic lactic acid bacteria and/or thermophilic lactic acid bacteria,
with the proviso that components (a) to (d) add up to 100 wt %.

### FIELD OF THE INVENTION

The invention is in the area of milk products and relates to acidified milk products and the resultant use thereof in end products, and methods of production of the products.

### PRIOR ART

Sauce is a liquid to thick seasoning addition to hot and cold dishes, salads and desserts. There are a number of basic sauces, for example espagnole sauce (a thickened sauce on the basis of a dark base) or velouté sauce (also white basic sauce), a sauce thickened with blond roux based on a light-coloured base or béchamel and hollandaise sauce. Tomato sauce is often included among the basic sauces.

Tomato sauce is a simple sauce based on boiled and strained tomatoes from Italian cuisine, which forms the basis of many dishes, e.g. spaghetti alla napoletana. It is presumed to have been invented in the 18th century in Southern Italy, when growing of the first large red varieties of tomato became established. The simplest form consists merely of tomatoes thickened by boiling, which were passed through a sieve to remove cores and skin. It is usually preserved by boiling and then processed further depending on the recipe. An ordinary Italian tomato sauce (salsa di pomodoro) additionally contains root vegetables such as carrot, blanched celery, onions and garlic, which are cooked lightly in oil before the tomatoes are added. The sauce, cooked to the desired consistency, is strained again, seasoned with salt and pepper, optionally also a little wine vinegar and sugar, and finally finished with olive oil. Often it is also seasoned with herbs such as basil, oregano, bay etc. In addition, there are numerous modifications and supplements with generally spicy ingredients, such as olives, anchovies, capers, pepperoncini or dried mushrooms.

For tomato sauce of classical cuisine (sauce tomate), streaky bacon, root vegetables and onions are finely diced and lightly browned in butter with thyme, basil and bay, dusted with flour, after brief further cooking topped up with stock or fish base, tomato puree is added and it is finally strained. It is served added to cooked meat or to seafood or processed further as a basic sauce depending on the recipe.

The aforementioned tomato-based basic sauce is generally also the basic covering on pizza dough. With few exceptions, such as for tarte flambée, for which the basic covering is crème fraîche, sour cream or cultured cream, the basic sauce for the covering on pizza is exclusively tomato-based. The tomato sauce is a very spicy sauce, in which the tomato basic taste is predominant and is very much to the fore. The tomato taste generally conceals the gustatory perception for the other spices in the tomato sauce, which have a finer note.

The aim of the present invention was therefore to provide a sauce or basic sauce as an alternative to tomato sauce, which avoids the aforementioned disadvantages in taste perception. Furthermore, the sauce or basic sauce should enhance the spicy taste notes of the other ingredients in the sauce. The sauce or basic sauce should in particular be usable as the basic covering sauce on pizza dough, wherein the pizza may be either a frozen pizza or a freshly made pizza. Therefore another aim of the invention was to provide a sauce or basic sauce that is smooth and has good fluidity, so that in the production of frozen pizza it can be applied on the dough quickly and easily by machine. Such a sauce or basic sauce should therefore have good stability in baking and freezing/thawing.

### DESCRIPTION OF THE INVENTION

The invention firstly relates to an acidified milk product, comprising
(a) 30 to 80 wt % milk,
(b) 5 to 80 wt % fat component,
(c) 0.5 to 4 wt % starch and
(d) 0.001 to 0.1 wt % of mesophilic lactic acid bacteria and/or thermophilic lactic acid bacteria,
   with the proviso that components (a) to (d) add up to 100 wt %.

It was found, surprisingly, that by using the acidified milk product according to the invention, a preparation with significantly improved taste is obtained, which admittedly has a slightly acidic taste, but, depending on the other spices added, leaves a rounded, palatable overall impression. In particular, the acidified milk product according to the invention does not have a tomato taste note that is too strong and masks all other taste notes.

In a preferred embodiment, the acidified milk product comprises
(a) 15 to 70 wt % milk,
(b) 10 to 40 wt % fat component,
(c) 1 to 3 wt % starch and
(d) 0.001 to 0.1 wt % of mesophilic lactic acid bacteria and/or thermophilic lactic acid bacteria,
   with the proviso that components (a) to (d) add up to 100 wt %.

The milk used may be milk with a fat content from 0.1% to 45%. Skimmed milk is preferably used.

The fat component is preferably milk fat that has a fat content from 10% to 45% or vegetable fat. The milk fat is preferably used in the form of cream in the acidified milk product according to the invention. Vegetable fats are also to be understood as vegetable oils. These are preferably borage oil, safflower oil, peanut oil, coconut oil, hemp oil, linseed oil, pumpkin seed oil, corn oil, poppy oil, evening primrose oil, olive oil, palm kernel oil, palm oil, rape oil, sunflower oil, sesame oil, soya oil, grapeseed oil, walnut oil, wheat germ oil.

The total fat content of the final composition is preferably made up of the fat content of the milk and of the fat component together. The total composition of the acidified milk product preferably has a total fat content from 0.1% to 45%.

Native and/or modified starch is preferably used as starch in the preparation according to the invention. The starch is preferably selected from corn, wheat or potato starch or the starches that in food legislation are deemed equivalent to native starches, the so-called physically modified starch, which is precooked.

Especially preferably, native starch is used as starch, because in contrast to the physically modified starch, it is of natural occurrence and is not, like the latter, declared as food additives.

Physically modified starches are preferably selected from the group consisting of:
(E 1400) dextrin
(E 1401) acid-treated (modified) starch
(E 1402) alkaline-modified starch
(E 1403) bleached starch
(E 1404) oxidized starch (oxidatively degraded starch)
(E 1405) enzymatically modified starch
(E 1410) monostarch phosphate
(E 1412) distarch phosphate
(E 1413) phosphatized distarch phosphate
(E 1414) acetylated distarch phosphate
(E 1420) acetylated starch
(E 1421) acetylated starch
(E 1422) acetylated distarch adipate
(E 1423) acetylated distarch glycerol
(E 1430) distarch glycerol
(E 1440) hydroxypropyl starch
(E 1441) hydroxypropyl distarch glycerol
(E 1442) hydroxypropyl distarch phosphate
(E 1450) starch sodium octenyl succinate (emulsifying starch)
(E 1451) acetylated oxidized starch.

Suitable as mesophilic bacterium are bacterial cultures that may be selected independently from the group consisting of: Lactococcus spp., Leuconostoc spp., Lactococcus lactis, Lactococcus lactis subspecies cremoris and Lactococcus lactis subspecies lactis. Especially preferred mesophilic starter cultures are cultured species that may be selected independently from the group consisting of: Lactococcus lactis subsp. lactis, Lactococcus lactis subsp. cremoris, Leuconostoc spec., Lactococcus lactis subsp. lactis biovar diacetylactis, Lactococcus lactis subsp. lactis biovar diacetylactis.

In the case of the thermophilic bacteria, these may be selected independently from the group consisting of Streptococcus spp., Bifidobacterium spp., Pediococcus spp., Lactobacillus spp., Streptococcus thermophilus, Lactobacillus delbrueckii or Lactobacillus delbrueckii subspecies bulgaricus. Especially preferred thermophilic starter cultures may be selected independently from the group consisting of: Sc. thermophilus, Lb. delbrueckii subsp. bulgaricus, Sc. thermophilus, Lb. acidophilus, Lactobacillus rhamnosus, Bifidobacterium ssp., Lactobacillus johnsonii, Lactobacillus casei, Lactobacillus paracasei.

Thermophilic lactic acid cultures from the company Chr. Hansen are especially preferred, such as for example YoFlex culture range or eXact® range, but bacterial cultures such as YoMix (from Danisco) or Delvo®-Yog (from DSM) are also suitable.

The optimum action of mesophilic lactic acid bacteria is preferably at a fermentation temperature from 23° C. to 34° C. and in the case of thermophilic lactic acid bacteria at 35° C. to 45° C.

Preferably the preparation according to the invention has a total fat content from 0.1% to 45%; a total fat content from 7% to 25% is preferred, and a total fat content from 10% to 20% is especially preferred, wherein the fat content is the sum of the fat content of the milk and of the fat component, which may be milk fat or vegetable fat.

In a preferred embodiment, the acidified milk product according to the invention additionally comprises taste-imparting substances, which determine the general taste of the final composition, which is selected from spicy, cheesy, pungent, umami, strong, exotic, bitter, salty, sour and/or sweet.

The term “taste-imparting substances” means the ingredients listed later in the description, which have an influence on the taste of the preparation and of the final composition. In particular, the term “taste-imparting substances” includes ingredients such as mixed herbs, spices and additives such as aroma substances.

The final composition is the composition that the (industrial) user finally uses for the corresponding application, for example as a covering sauce on pizza dough or a spread on bread.

The acidified milk product according to the invention does not contain a tomato basic sauce. That is, it does not contain tomato-based ingredients that are used as tomato basic sauce, so that the tomato taste predominates and the other taste notes as described above are concealed. This does not exclude the addition of tomato spices that give the preparation a slight tomato note.

Furthermore, the acidified milk product according to the invention may comprise, as optional component, other additives that are selected from the group of buttermilk, aroma substances, salt, sugar, herbs, spices, garlic, onions, acidifying agents, stabilizers and antioxidants.

The invention relates secondly to the use of the acidified milk product as sauce, covering sauce, spread or dip.

In a preferred embodiment as spread or dip, such a preparation comprises
(a) 30 wt % to 80 wt % quark, preferably low-fat quark,
(b) 20 wt % to 70 wt % acidified milk product according to the invention,
(c) 0.1 wt % to 0.5 wt % herbs,
(d) 0.5 wt % to 1 wt % water,
(e) 0.5 wt % to 0.8 wt % salt, wherein the components add up to 100 wt %.

The herbs may be mixed herbs from various herb ingredients, such as parsley, horseradish, onion, chives etc. For making the spread or dip, all the ingredients are mixed (>10° C.) and stirred until homogeneous.

The acidified milk product according to the invention has very good baking and freezing/thawing stability. When used in or on frozen products, the preparation according to the invention does not display any grainy and broken structure. It is creamy, massive and solid and supports the taste notes of other ingredients particularly well. Therefore a preferred use of the acidified milk product is as covering sauce for pizza, especially for making the covering sauce on frozen pizza.

Therefore the invention further relates to the use of the acidified milk product according to the invention as a preparation with good baking and freezing/thawing stability in or on frozen products, and preferably frozen pizza.

The invention further relates to the use of the acidified milk product for improving the taste in the final composition selected from spicy, cheesy, pungent, umami, strong, exotic, bitter, salty, sour and/or sweet.

Through the use of the preparation according to the invention, which is a combination of substances that are good taste vehicles, and at the same time have only quite a slight taste of their own, simultaneously with the slightly sour note of the acidified milk product, which has a refreshing taste, the general taste of the final composition can be improved and simultaneously supported.

Another great advantage of the preparation according to the invention based on acidified-milk products is the positive nutrition-physiological contribution of acidified milk to the digestion, due to the lactic acid. Moreover, acidified milk products have a pleasant fresh taste and are very digestible, as the lactoprotein is in cleaved form, so that the minerals in milk can be better absorbed by the body.

In a preferred embodiment, the acidified-milk-based preparation according to the invention for taste improvement is applied as a covering sauce on pizza, especially frozen pizza. Therefore the present invention also comprises a pizza covering sauce comprising the acidified milk product according to the invention, with the proviso that the pizza covering sauce does not contain a tomato basic sauce.

It is found that the acidified milk product according to the invention not only has a taste advantage, compared to the very strong-tasting tomato basic sauce, but also has good baking and freezing/thawing stability, so that it is very suitable for use on frozen pizza.

The present invention further relates to the production of the acidified milk product according to the invention. For production of the preparation, milk, cream and starch are put in a mixing bowl and stirred. Next it is heated to approx. 50° C. to 95° C., preferably 55° C. to 75° C., especially preferably 65° C. to 70° C. and is homogenized in the first stage at 10 to 40 bar, preferably 15 to 30 bar and in the second stage at 2 to 10 bar, preferably 5 to 7 bar. It is then heated to 80° C. to 120° C., preferably 90° C. to 110° C., especially preferably 95° C. to 100° C., and held at this temperature for 300 s to 500 s, preferably 340 s to 450 s, especially preferably 360 s to 400 s. Then it is cooled to 30° C. to 50° C., preferably 35° C. to 45° C., especially preferably 30° C. to 40° C. The mixture is then inoculated with lactic acid cultures and is incubated in the warming cabinet, preferably at a temperature from 30° C. to 45° C. for approx. 24 hours until the acidified milk base is obtained.

The present invention also further relates to the acidified milk base mass with improved taste properties, obtainable by
(i) stirring milk and cream and starch in a mixer, warming and homogenizing under pressure, and then heating,
(ii) inoculating the resultant mixture with lactic acid cultures and
(iii) incubating in a suitable temperature range until pH<4.6 is reached,
(iv) wherein mesophilic and/or thermophilic lactic acid cultures are used as lactic acid cultures and the resultant acidified milk base mass has no more than 20% total fat content, preferably no more than 10% total fat content.

The present invention also further relates to the method of production of frozen pizza with the preparation according to the present invention as basic covering sauce. In this case, pizza dough is prepared for example by stirring, kneading and portioning the dough by machine in a closed container. Then the dough is matured and in a next step is pressed in baking tins or stamped out. Prior to baking, the preparation based on sour milk according to the invention is applied. The prepared bases then travel in the tray through the oven and are baked briefly at around 370° C. After the pre-baking, the pizza may then be covered with further ingredients and cheese, before being quick-frozen.

A preferred embodiment is the method of production of frozen pizza, wherein in the first step
(i) the dough is prepared, and then
(ii) the acidified milk product according to the invention is applied on the prepared dough, and then
(iii) the dough is prebaked with the sauce in the baking oven, and then
(iv) optionally further ingredients are applied and
(v) it is quick-frozen.

Possible further ingredients are garlic, onion and other vegetables, and other edible foodstuffs.

Production of Sour Milk¹ ¹ http://lebensmittlellexikon.de/s000200.php

Acidified milk products are as a rule produced using cultured lactic acid bacteria. Prior to inoculation with lactic acid bacteria, the milk (e.g. skimmed milk) is adjusted to the target fat content, pasteurized and homogenized. The inoculated milk is caused to coagulate at certain temperatures. A person skilled in the art also says that the milk is incubated. With the cultured bacteria, particular acidities may be established. As soon as a particular acidity is reached, the milk is cooled rapidly, to stop the activity of the lactic acid bacteria. The acid that forms naturally is a preservative, therefore sour milk products keep longer than milk products that have only been pasteurized. Sour milk products are characterized by three features: taste, texture and fat content. The details are as follows: the taste is different from one manufacturer to another. It ranges from mild to very sour. The taste is determined by targeted interruption of the acidification and the choice of particular bacterial cultures. The texture of a sour milk product is compact after acidification—it can be spooned. What is decisive, when the user receives it, is whether or not it is sold in the container in which it was acidified. In the case of acidification in large-volume tanks, the milk must be stirred until thick before filling. The milk is no longer solid and is drinkable. If, however, milk is acidified directly in the packaging tubs, it is offered as compact sour milk.

Yoghurt and sour milk are very similar. Yoghurt, however, is rather more viscous than fermented milk and has a more intense taste. The main difference is in selection of the lactic acid bacteria during production. Yoghurt requires so-called thermophilic cultures (Lactobacillus bulgaricus and Streptococcus thermophilus), with optimum growth at 35° C. to 45° C.

For production of fermented milk, cultures of mesophilic lactic acid bacteria are used, for which the optimum is at temperatures of about 22° C. to 33° C. The production process for fermented milk takes 14 to 18 hours at approx. 25° C.

### Production of Cream

Cream in its various forms is produced by the creaming of milk. In this process, the milk separates, with the emulsified milk fat-emulsion droplets rising to the surface owing to their lower density, where they float as cream, which can be skimmed off as such, and skimmed milk sinks to the bottom as the heavier phase. A prerequisite for natural creaming is that the milk has not been homogenized, as this reduces the size of the fat globules and they acquire a new structure, which makes creaming slower. As a rule, today cream is no longer obtained by creaming, but by centrifuging. In this case as much milk fat as possible is removed, so that the remaining skimmed milk only has a fat content from 0.01% to 0.06%. The desired fat content of the end product is achieved by remixing the two products. Goods bearing the designation cream must have a minimum fat content of 10%.

Compared to milk, cream contains less lactoprotein, and therefore more fat and fat-soluble vitamins. It is the starting product for making butter and cheese, but is also used “sweet” or freshly acidified in the kitchen.

### Food Ingredients

### A. Herb Preparation/Spices

There is no restriction on the type of herbs that are present in the preparation according to the invention and the final composition. In addition, the herb preparation or spices may also contain salt, sugar, garlic and onion.

For example, herbs and spices such as wild garlic, basil, mugwort, savory, borage, watercress, dill, tarragon, chervil, cress, lovage, marjoram, balm, mint, oregano, paprika, parsley, dried tomato powder, pepper, burnet saxifrage, rosemary, sage, sorrel, chives, thyme, hyssop may be present, individually or in any combinations. Furthermore, so-called Indian, Asian or exotic herbs and spices may be used. These may be for example coriander, cardamom, ginger, saffron, lemongrass, curry, chilli, cloves. Basically any kind of edible herbs may be incorporated.

The herbs may be added in any form. They may for example be present in chopped, finely cut form, as extract, in fresh form or in dried, frozen or heat-treated form.

In a first embodiment, the preparations contain herbs in the form of finely chopped fresh herbs. Alternatively a water-based herb paste may also be used, which preferably has a water content from about 50 to about 85 wt %.

It has proved advantageous to use a previously prepared herb paste with a water content from approx. 20 to 85 wt % and a dry matter content from 25 to 85 wt %, preferably for example 55 wt % water content and a dry matter content of about 45 wt %. The herb paste may contain various fresh, frozen or dried herbs and/or spices, as required. In a preferred embodiment the herb paste contains among other things for example herbs, salt, spices, garlic and onions. The herb paste is used in the acidified milk product in an amount from 3 to 15%, preferably 6 to 15%.

### B. Vegetable Fats and Vegetable Oils

As explained above, the concomitant use of vegetable fats or vegetable oils is not a requirement for the preparations according to the invention. However, in certain specific cases it may be advantageous to use small amounts of these substances as well, up to 5 wt % relative to the preparation.

Vegetable fats give the herb preparation greater stability of form at room temperature. They serve as a matrix for the composition. Natural vegetable fats, e.g. hardened palm oil or coconut oil, in particular, are suitable for this.

Conversely, vegetable oils endow the composition with even lower viscosity and contribute to formability at refrigerator temperatures. Examples of this are rape oil, sunflower oil, corn oil and olive oil.

### C. Aroma Substances

The preparations according to the invention may contain one or more aroma substances. Typical examples comprise: acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineol, cinnamyl acetate, citral, citronellol, citronellal, citronellyl acetate, cyclohexyl acetate, cymene, damascone, decalactone, dihydrocoumarin, dimethyl anthranilate, dimethyl anthranilate, dodecalactone, ethoxyethyl acetate, ethylbutyric acid, ethyl butyrate, ethyl caprate, ethyl caproate, ethyl crotonate, ethyl furaneol, ethyl guaiacol, ethyl isobutyrate, ethyl isovalerate, ethyl lactate, ethylmethyl butyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyldihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzylacetone, isoamyl alcohol, isoamyl isovalerate, isobutyl butyrate, isobutyraldehyde, isoeugenol methyl ether, isopropyl methylthiazole, lauric acid, levulinic acid, linalool, linalool oxide, linalyl acetate, menthol, menthofuran, methylanthranilate, methylbutanol, methylbutyric acid, 2-methylbutyl acetate, methyl caproate, methyl cinnamate, 5-methyl furfural, 3,2,2-methylcyclopentenolone, 6,5,2-methyl heptenone, methyldihydrojasmonate, methyljasmonate, 2-methylmethyl butyrate, 2-methyl-2-pentenolic acid, methylthiobutyrate, 3,1-methylthiohexanol, 3-methylthiohexyl acetate, nerol, neryl acetate, trans,trans-2,4-nonadienal, 2,4-nonadienol, 2,6-nonadienol, 2,4-nonadienol, nootkatone, delta octalactone, gamma octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl alcohol, phenylethyl isovalerate, piperonal, propionaldehyde, propyl butyrate, pulegone, pulegol, sinensal, sulphurol, terpinene, terpineol, terpinolene, 8,3-thiomenthanone, 4,4,2-thiomethylpentanone, thymol, delta-undecalactone, gamma-undecalactone, valencene, valeric acid, vanillin, acetoin, ethyl vanillin, ethyl vanillin isobutyrate (=3-ethoxy-4-isobutyryloxybenzaldehyde), 2,5-dimethyl-4-hydroxy-3(2H)-furanone and derivatives thereof (of these, preferably homofuraneol (=2-ethyl-4-hydroxy-5-methyl-3(2H)-furanone), homofuronol (=2-ethyl-5-methyl-4-hydroxy-3(2H)-furanone and 5-ethyl-2-methyl-4-hydroxy-3(2H)-furanone), maltol and maltol derivatives (of these, preferably ethyl maltol), coumarin and coumarin derivatives, gamma-lactones (of these, preferably gamma-undecalactone, gamma-nonalactone, gamma-decalactone), delta-lactones (of these, preferably 4-methyldeltadecalactone, massoilactone, deltadecalactone, tuberolactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, acetic acid isoamyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenylglycidate, ethyl-2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenyl acetaldehyde, 2-methyl-3-(methylthio)furan, 2-methyl-3-furanthiol, bis(2-methyl-3-furyl)disulphide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetyl pyrazine, 2-pentyl pyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guaiacol, 3-hydroxy-4,5-di methyl-2(5H)-furanone, 3-hydroxy-4-methyl-5-ethyl-2(5H)-furanone, cinnamaldehyde, cinnamyl alcohol, methylsalicylate, isopulegol and (not explicitly stated here) stereoisomers, enantiomers, positional isomers, diastereomers, cis/trans isomers or epimers of these substances.

### D. Acidifying Agents and Antioxidants

Within the EU, these substances must also satisfy the food regulations. The following acidifying agents or antioxidants may come into consideration:

E 300 ascorbic acid
E 301 sodium ascorbate
E 302 calcium ascorbate
E 304 ascorbyl palmitate/ascorbyl stearate
E 306 tocopherol-containing extracts
E 307 alpha-tocopherol
E 308 gamma-tocopherol
E 309 delta-tocopherol
E 310 propyl gallate
E 311 octyl gallate
E 312 dodecyl gallate
E 315 isoascorbic acid
E 316 sodium isoascorbate
E 319 tert.-butylhydroquinone
E 320 butylated hydroxyanisole (BHA)
E 321 butylated hydroxytoluene (BHT)
E 322 lecithin
E 325 sodium lactate
E 326 potassium lactate
E 327 calcium lactate
E 330 citric acid
E 331 mono-/di-/trisodium citrate
E 332 monopotassium citrate, tripotassium citrate
E 333 monocalcium citrate, dicalcium citrate, tricalcium citrate
E 334 L-(+)-tartaric acid
E 335 monosodium tartrate, disodium tartrate
E 336 monopotassium tartrate, dipotassium tartrate
E 337 potassium sodium tartrate
E 338 phosphoric acid
E 339 monosodium phosphate, disodium phosphate, trisodium phosphate
E 340 monopotassium phosphate, dipotassium phosphate, tripotassium phosphate
E 341 monocalcium phosphate, dicalcium phosphate, tricalcium phosphate
E 343 magnesium phosphates
E 350 sodium hydrogen malate, sodium malate
E 351 potassium malate
E 352 calcium malate, calcium hydrogen malate
E 353 meta-tartaric acid
E 354 calcium tartrate
E 355 adipic acid
E 356 sodium adipate
E 357 potassium adipate
E 363 succinic acid
E 380 ammonium citrate
E 385 calcium-disodium methylenediamine tetrahydrate
E 392 rosemary extract

### E. Acid Regulators

Acid regulators are food additives with which the acidity or the basicity and thus the desired pH of a foodstuff are kept constant. They are generally organic acids and salts thereof, carbonates, but less often also inorganic acids and salts thereof. Addition of an acid regulator sometimes increases the stability and strength of the foodstuff, brings about desirable precipitation and improves the action of preservatives. In contrast to acidifying agents, they are not used for changing the taste of foodstuffs. Their action is based on the formation of a buffer system in the foodstuff, so that addition of acidic or basic substances causes no change, or only a slight change, in pH. Examples are:

E 170—calcium carbonate
E 260-263—acetic acid and acetates
E 270—lactic acid
E 296—malic acid
E 297—fumaric acid
E 325-327—lactates (lactic acid)
E 330-333—citric acid and citrates
E 334-337—tartaric acid and tartrates
E 339-341—orthophosphates
E 350-352—malates (malic acid)
E 450-452—di-, tri- and polyphosphates
E 500-504—carbonates (carbonic acid)
E 507—hydrochloric acid and chlorides
E 513-517—sulphuric acid and sulphates
E 524-528—hydroxides
E 529-530—oxides
E 355-357—adipic acid and adipates
E 574-578—gluconic acid and gluconates

### F. Thickening Agents

Thickening agents are substances which, primarily, are able to bind water. Withdrawal of unbound water leads to an increase in viscosity. Starting from a characteristic concentration for each thickening agent, this effect is also accompanied by network effects, which lead to a generally disproportionate increase in viscosity. In this case molecules are said to “communicate” with one another, i.e. loop together. Most thickening agents are linear or branched macromolecules (e.g. polysaccharides or proteins), which can interact with one another by intermolecular interactions, such as hydrogen bridges, hydrophobic interactions or ionic bonds. Extreme cases of thickening agents are sheet silicates (bentonites, hectorites) or hydrated SiO₂ particles, which are present dispersed as particles and can bind water in their solid-like structure or can interact with one another owing to the interactions described above. Examples are:

E 400—alginic acid
E 401—sodium alginate
E 402—potassium alginate
E 403—ammonium alginate
E 404—calcium alginate
E 405—propylene glycol alginate
E 406—agar-agar
E 407—carrageen, furcelleran
E 407—carob-seed flour
E 412—guar bean flour
E 413—tragacanth
E 414—gum arabic
E 415—xanthan
E 416—karaya (Indian tragacanth)
E 417—tara seed flour (Peruvian carob-seed flour)
E 418—gellan
E 440—pectins
E 440ii—amidated pectin
E 460—microcrystalline cellulose, cellulose powder
E 461—methylcellulose
E 462—ethylcellulose
E 463—hydroxypropylcellulose
E 465—methylethylcellulose
E 466—carboxymethylcellulose, sodium carboxymethylcellulose

### G. Reducing Agents

Furthermore, foodstuffs may also contain reducing agents. Reducing agents in the sense of the invention are preferably reducing agents that are permitted in foodstuffs, especially those mentioned hereunder:

E 220—sulphur dioxide
E 221—sodium sulphite
E 222—sodium hydrogen sulphite
E 223—sodium bisulphite
E 224—potassium bisulphite
E 226—calcium sulphite
E 227—calcium hydrogen sulphite
E 228—potassium hydrogen sulphite
E 300—ascorbic acid
E 301—sodium L-ascorbate
E 302—potassium L-ascorbate
E 304—ascorbic acid esters
E 306—tocopherol
E 307—alpha-tocopherol
E 308—gamma-tocopherol
E 309—delta-tocopherol
E 310—propyl gallate
E 311—octyl gallate
E 312—dodecyl gallate
E 315—isoascorbic acid
E 316—sodium isoascorbate
E 319—tert.-butylhydroquinone (TBHQ)
E 320—butylated hydroxyanisole
E 321—butylated hydroxytoluene
E 322—lecithin
E 330—citric acid
E 512—tin(II) chloride

### H. Flavour Enhancers

These preparations—as well as the mixtures of flavourings—may moreover contain additional aroma substances for intensifying a salty, optionally slightly sour and/or umami taste impression. Thus, the products according to the invention or mixtures of flavourings are used in combination with at least one other substance suitable for intensifying a pleasant taste impression (salty, umami, optionally slightly sour). Salty tasting compounds and salt-intensifying compounds are preferred for this. Preferred compounds are disclosed in WO 2007/045566. Umami compounds, as described in WO 2008/046895 and EP 1 989 944, are especially preferred.

Furthermore, mixtures of flavourings and products that are preferred according to the invention may also comprise aroma substances for masking bitter and/or astringent taste impressions (taste correctants). The (further) taste correctants are selected for example from the following list: nucleotides (e.g. adenosine-5′-monophosphate, cytidine-5′-monophosphate) or pharmaceutically acceptable salts thereof, lactisoles, sodium salts (e.g. sodium chloride, sodium lactate, sodium citrate, sodium acetate, sodium gluconate), further hydroxyflavanones (e.g. eriodictyol, homoeriodictyol or sodium salts thereof), especially according to US 2002/0188019, hydroxybenzoic acid amides according to DE 10 2004 041 496 (e.g. 2,4-dihydroxybenzoic acid vanillyl amide, 2,4-dihydroxybenzoic acid-N-(4-hydroxy-3-methoxybenzyl)amide, 2,4,6-trihydroxybenzoic acid-N-(4-hydroxy-3-methoxybenzyl)amide, 2-hydroxybenzoic acid-N-4-(hydroxy-3-methoxybenzyl)amide, 4-hydroxybenzoic acid-N-(4-hydroxy-3-methoxybenzyl)amide, 2,4-dihydroxybenzoic acid-N-(4-hydroxy-3-methoxybenzyl)amide monosodium salt, 2,4-dihydroxybenzoic acid-N-2-(4-hydroxy-3-methoxyphenyl)ethylamide, 2,4-dihydroxybenzoic acid-N-(4-hydroxy-3-ethoxybenzyl)amide, 2,4-dihydroxybenzoic acid-N-(3,4-dihydroxybenzyl)amide and 2-hydroxy-5-methoxy-N-[2-(4-hydroxy-3-methoxyphenyl)ethyl]amide (Aduncamid), 4-hydroxybenzoic acid vanillyl amide), bitter-masking hydroxydeoxybenzoins e.g. according to WO 2006/106023 (e.g. 2-(4-hydroxy-3-methoxyphenyl)-1-(2,4,6-trihydroxyphenyl)ethanone, 1-(2,4-dihydroxyphenyl)-2-(4-hydroxy-3-methoxyphenyl)ethanone, 1-(2-hydroxy-4-methoxyphenyl)-2-(4-hydroxy-3-methoxyphenyl)ethanone), amino acids (e.g. gamma-aminobutyric acid according to WO 2005/096841 for reducing or masking an unpleasant taste impression such as bitterness), malic acid glycosides according to WO 2006/003107, salty tasting mixtures according to PCT/EP 2006/067120, diacetyl trimers according to WO 2006/058893, mixtures of whey proteins with lecithins and/or bitter-masking substances such as gingerdiones according to WO 2007/003527.

Preferred aroma substances are those that produce a sweet odour impression, wherein the further aroma substance or substances are preferably selected from the group consisting of: vanillin, ethyl vanillin, ethyl vanillin isobutyrate (=3-ethoxy-4-isobutyryloxybenzaldehyde), furaneol (2,5-dimethyl-4-hydroxy-3(2H)-furanone) and derivatives (e.g. homofuraneol, 2-ethyl-4-hydroxy-5-methyl-3(2H)-furanone), homofuronol (2-ethyl-5-methyl-4-hydroxy-3(2H)-furanone and 5-ethyl-2-methyl-4-hydroxy-3(2H)-furanone), maltol and derivatives (e.g. ethyl maltol), coumarin and derivatives, gamma-lactones (e.g. gamma-undecalactone, gamma-nonalactone), delta-lactones (e.g. 4-methyldeltalactone, massoilactone, deltadecalactone, tuberolactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, fruit esters and fruit lactones (e.g. acetic acid-n-butyl ester, acetic acid isoamyl ester, propionic acid ethyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenylglycidate, ethyl-2-trans-4-cis-decadienoate), 4-(p-hydroxyphenyl)-2-butanone, 1,1-dimethoxy-2,2,5-trimethyl-4-hexane, 2,6-dimethyl-5-hepten-1-al, 4-hydroxycinnamic acid, 4-methoxy-3-hydroxycinnamic acid, 3-methoxy-4-hydroxycinnamic acid, 2-hydroxycinnamic acid, 2,4-dihydroxybenzoic acid, 3-hydroxybenzoic acid, 3,4-dihydroxybenzoic acid, vanillic acid, homovanillic acid, vanillomandelic acid and phenylacetaldehyde.

### I. Active Substances for Masking Unpleasant Taste Impressions

Furthermore, the oral preparations may also comprise further substances that also serve for masking bitter and/or astringent taste impressions. These further taste correctants are selected for example from the following list: nucleotides (e.g. adenosine-5′-monophosphate, cytidine-5′-monophosphate) or physiologically acceptable salts thereof, lactisoles, sodium salts (e.g. sodium chloride, sodium lactate, sodium citrate, sodium acetate, sodium gluconate), hydroxyflavanones, and preferably eriodictyol, sterubin (eriodictyol-7-methyl ether), homoeriodictyol, and sodium, potassium, calcium, magnesium or zinc salts thereof (especially such as described in EP 1258200 A2, which, with respect to the corresponding compounds disclosed therein, forms part of this application by reference), hydroxybenzoic acid amides, and preferably 2,4-dihydroxybenzoic acid vanillyl amide, 2,4-dihydroxybenzoic acid-N-(4-hydroxy-3-methoxybenzyl)amide, 2,4,6-trihydroxybenzoic acid-N-(4-hydroxy-3-methoxybenzyl)amide, 2-hydroxybenzoic acid-N-4-(hydroxy-3-methoxybenzyl)amide, 4-hydroxybenzoic acid-N-(4-hydroxy-3-methoxybenzyl)amide, 2,4-dihydroxybenzoic acid-N-(4-hydroxy-3-methoxy-benzyl)amide monosodium salt, 2,4-dihydroxybenzoic acid-N-2-(4-hydroxy-3-methoxyphenyl)ethylamide, 2,4-dihydroxybenzoic acid-N-(4-hydroxy-3-ethoxybenzyl)amide, 2,4-dihydroxybenzoic acid-N-(3,4-dihydroxybenzyl)amide and 2-hydroxy-5-methoxy-N-[2-(4-hydroxy-3-methoxyphenyl)ethyl]amide; 4-hydroxybenzoic acid vanillyl amides (especially as described in WO 2006/024587, which, with respect to the corresponding compounds disclosed therein, forms part of this application by reference); hydroxydeoxybenzoins, and preferably 2-(4-hydroxy-3-methoxyphenyl)-1-(2,4,6-trihydroxyphenyl)ethanone, 1-(2,4-dihydroxyphenyl)-2-(4-hydroxy-3-methoxyphenyl)-ethanone and 1-(2-hydroxy-4-methoxyphenyl)-2-(4-hydroxy-3-methoxyphenyl)ethanone) (especially as described in WO 2006/106023, which, with respect to the corresponding compounds disclosed therein, forms part of this application by reference); hydroxyphenylalkanedione, such as for example gingerdione-[2], gingerdione-[3], gingerdione-[4], dehydrogingerdione-[2], dehydrogingerdione-[3], dehydrogingerdione-[4]) (especially as described in WO 2007/003527, which, with respect to the corresponding compounds disclosed therein, forms part of this application by reference); diacetyl trimers (especially as described in WO 2006/058893, which, with respect to the corresponding compounds disclosed therein, forms part of this application by reference); gamma-aminobutyric acids (especially as described in WO 2005/096841, which, with respect to the corresponding compounds disclosed therein, forms part of this application by reference); divanillins (especially as described in WO 2004/078302, which, with respect to the corresponding compounds disclosed therein, forms part of this application by reference) and 4-hydroxydihydrochalcones (preferably as described in US 2008/0227867 A1, which, with respect to the corresponding compounds disclosed therein, forms part of this application by reference), and especially phloretin and davidigenin, amino acids or mixtures of whey proteins with lecithins, hesperetin as disclosed in WO 2007/014879, which, with respect to these compounds, forms part of this application by reference, 4-hydroxydihydrochalcones as disclosed in WO 2007/107596, which, with respect to these compounds, forms part of this application by reference, or propenylphenyl glycosides (chavicol glycosides) as described in EP 1955601 A1, which, with respect to these compounds, form part of this application by reference, or extracts from Rubus suavissimus, extracts from Hydrangea macrophylla as described in EP 2298084 A1, pellitorin and derived aroma compositions as described in EP 2008530 A1, umami compounds as described in WO 2008/046895 A1 and EP 1989944 A1, umami compounds as described in EP 2064959 A1 or EP 2135516 A1, vanillyl lignans, enterodiol, and N-decadienoylamino acids and mixtures thereof.

### J. Antioxidants

Both natural and artificial antioxidants are used in the food industry. Natural and artificial antioxidants differ primarily in that the former occur naturally in food and the latter are produced artificially. Thus, natural antioxidants that are to be used as food additives are for example obtained from vegetable oils. Vitamin E—also known as tocopherol—for example is often produced from soya oil. Synthetic antioxidants such as propyl gallate, octyl gallate and dodecyl gallate, in contrast, are obtained by chemical synthesis. The gallates may trigger allergies in sensitive people. Other antioxidants usable in compositions of the present invention are: sulphur dioxide, E 220 sulphites sodium sulphite, E 221 sodium hydrogen sulphite, E 222 sodium bisulphite, E 223 potassium bisulphite, E 224 calcium sulphite, E 226 calcium hydrogen sulphite, E 227 potassium hydrogen sulphite, E 228 lactic acid, E 270 ascorbic acid, E 300 sodium L-ascorbate, E 301 calcium L-ascorbate, E 302 ascorbic acid esters, E 304 tocopherol, E 306 alpha-tocopherol, E 307 gamma-tocopherol, E 308 delta-tocopherol, E 309 propyl gallate, E 310 octyl gallate, E 311 dodecyl gallate, E 312 isoascorbic acid, E 315 sodium isoascorbate, E 316 tert.-butylhydroquinone (TBHQ), E 319 butylated hydroxyanisole, E 320 butylated hydroxytoluene, E 321 lecithin, E 322 citric acid, E 330 salts of citric acid (E 331 & E 332) sodium citrate, E 331 potassium citrate, E 332 calcium disodium EDTA, E 385 diphosphates, E 450 disodium diphosphate, E 450a trisodium diphosphate, E 450b tetrasodium diphosphate, E 450c dipotassium diphosphate, E 450d tripotassium diphosphate, E 450e dicalcium diphosphate, E 450f calcium dihydrogen diphosphate, E 450g triphosphates, E 451 pentasodium triphosphate, E 451a pentapotassium triphosphate, E 451b polyphosphate, E 452 sodium polyphosphate, E 452a potassium polyphosphate, E 452b sodium calcium polyphosphate, E 452c calcium polyphosphate, E 452d tin-II chloride, E 512.

### K. Emulsifiers

Emulsifiers are characterized by the important property of being soluble both in water and in fat. Emulsifiers generally consist of a fat-soluble and a water-soluble part. They are always used when water and oil are to be mixed to form a stable, homogeneous mixture.

Suitable emulsifiers that are used in the food processing industry are selected from: ascorbyl palmitate (E 304) lecithin (E 322) phosphoric acid (E 338) sodium phosphate (E 339) potassium phosphate (E 340) calcium phosphate (E 341) magnesium orthophosphate (E 343) propylene glycol alginate (E 405) polyoxyethylene(8)stearate (E 430) polyoxyethylene stearate (E 431) ammonium phosphatides (E 442) sodium phosphate and potassium phosphate (E 450) sodium salts of edible fatty acids (E 470 a) mono- and diglycerides of edible fatty acids (E 471) acetic acid monoglycerides (E 472 a) lactic acid monoglycerides (E 472 b) citric acid monoglycerides (E 472 c) tartaric acid monoglycerides (E 472 d) diacetyltartaric acid monoglycerides (E 472 e) sugar esters of edible fatty acids (E 473) sugar glycerides (E 474) polyglycerides of edible fatty acids (E 475) polyglycerol-polyricinoleate (E 476) propylene glycol esters of edible fatty acids (E 477) sodium stearoyl lactylate (E 481) calcium stearoyl-2-lactylate (E 482) stearyl tartrate (E 483) sorbitan monostearate (E 491) stearic acid (E 570).

### L. Food Colorants

Food colorants or simply colorants are food additives for colouring foodstuffs. Colorants are divided into the groups of natural colorants and synthetic colorants. The nature-identical colorants are also of synthetic origin. The nature-identical colorants are synthetic imitations of naturally occurring colouring substances. Suitable colorants for use in the present composition are selected from:

curcumin, E 100 riboflavin, lactoflavin, vitamin B2, E 101 tartrazine, E 102 quinoline yellow, E 104 yellow-orange S, yellow-orange RGL, E 110 cochineal, carminic acid, true carmine, E 120 azorubine, carmoisin, E 122 amaranth, E 123 cochineal red A, Ponceau 4 R, Victoria scarlet 4 R, E 124 erythrosin, E 127 allura red AC, E 129 Patent Blue V, E 131 indigotine, indigo-carmine, E 132 Brilliant Blue FCF, Patent Blue AE, amide blue AE, E 133 chlorophylls, chlorophylline, E 140 copper complexes of chlorophylls, copper-chlorophyllin complex, E 141 brilliant acid green, green S, E 142 caramel, E 150 a sulphite lye-caramel, E 150 b ammonia caramel, E 150 c ammonium sulphite-caramel, E 150 d brilliant black FCF, brilliant black PN, black PN, E 151 vegetable carbon, E 153 brown FK, E 154 brown HT, E 155 carotene, E 160 a annatto, bixin, norbixin, E 160 b capsanthin, capsorubin, E 160 c lycopene, E 160 d beta-apo-8′-carotenal, apocarotenal, beta-apocarotenal, E 160 e beta-apo-8′-carotene acid-ethyl ester (C30), apocarotene ester, beta-carotene acid ester, E 160 f lutein, xanthophyll, E 161 b canthaxanthine, E 161 g betanin, beet red, E 162 anthocyans, E 163 calcium carbonate, E 170 titanium dioxide, E 171 iron oxides, iron hydroxides, E 172 aluminium, E 173 silver, E 174 gold, E 175 lithol-rubin BK, rubin pigment BK, E 180.

### M. Sweeteners

As sweeteners or sweet-tasting additives, consideration may be given firstly to carbohydrates and especially sugars, such as sucrose/saccharose, trehalose, lactose, maltose, melizitose, raffinose, Palatinose, lactulose, D-fructose, D-glucose, D-galactose, L-rhamnose, D-sorbose, D-mannose, D-tagatose, D-arabinose, L-arabinose, D-ribose, D-glycerolaldehyde, or maltodextrin. Plant preparations that contain these substances are also suitable, for example based on sugar beet (Beta vulgaris ssp., sugar fractions, sugar syrup, molasses), sugar cane (Saccharum officinarum ssp., molasses, sugar cane syrup), maple syrup (Acer ssp.) or agave (agave syrup).

The following also come into consideration
synthetic, i.e. as a rule enzymatically produced starch or sugar hydrolysates (invert sugar, fructose syrup);
fruit concentrates (e.g. based on apples or pears);
sugar alcohols (e.g. erythritol, threitol, arabitol, ribitol, xylitol, sorbitol, mannitol, dulcitol, lactitol);
proteins (e.g. miraculin, monellin, thaumatin, curculin, brazzein);
sweeteners (e.g. MAGAP, sodium cyclamate, acesulfame K, neohesperidin dihydrochalcone, saccharin sodium salt, aspartame, superaspartame, neotame, alitame, sucralose, steviosides, rebaudiosides, lugduname, carrelame, sucrononate, sucrooctate, monatin, phenylodulcin);
sweet-tasting amino acids (e.g. glycine, D-leucine, D-threonine, D-asparagine, D-phenylalanine, D-tryptophan, L-proline);
other sweet-tasting low-molecular substances, e.g. hernandulcin, dihydrochalcone glycosides, glycyrrhizin, glycyrrhetic acid, derivatives and salts thereof, extracts of liquorice (Glycyrrhiza glabra ssp.), Lippia dulcis extracts, Momordica ssp. extracts or
individual substances, e.g. Momordica grosvenori [Luo Han Guo] and the mogrosides obtained therefrom, Hydrangea dulcis or Stevia ssp. (e.g. Stevia rebaudiana) extracts.

### INDUSTRIAL USABILITY

The present application further relates to acidified milk products, comprising
(a) 30 to 80 wt % milk,
(b) 5 to 80 wt % fat component,
(c) 0.5 to 4 wt % starch and
(d) 0.001 to 0.1 wt % of mesophilic lactic acid bacteria and/or thermophilic lactic acid bacteria,
   with the proviso that components (a) to (d) add up to 100 wt %, as so-called semi-finished goods or intermediates.

Preferably an acidified milk product of this kind comprises, as so-called semi-finished goods or intermediates:
(a) 15 to 70 wt % milk,
(b) 10 to 40 wt % fat component,
(c) 1 to 3 wt % starch and
(d) 0.001 to 0.1 wt % of mesophilic lactic acid bacteria and/or thermophilic lactic acid
bacteria,
   with the proviso that components (a) to (d) add up to 100 wt %.

For manufacturers, the sauce according to the invention based on acidified milk is especially advantageous, as it has very good baking and freezing/thawing stability and, as semi-finished goods or intermediates, already displays broad coverage, so that many end products may be produced therefrom. Especially owing to its particularly good properties, it is especially useful as a semi-finished product for use as a covering sauce on frozen pizza.

The present application also relates to a kit containing a vessel, containing the acidified-milk-based preparation according to the invention and a previously prepared pizza dough, which merely requires cooking before it is eaten.

### EXAMPLES

### Example 1

### (a) Production of the Preparation Based on Sour Milk

68.2 wt % of skimmed milk with a fat content of approx. 0.1% and 29.8 wt % of cream with a fat content of 34% and 2 wt % of native starch (Novation Endura 0100) are stirred in a mixer for 60 minutes. Then this is warmed to 65° C. and homogenized at a pressure of 30/5 bar. Heating takes place at 95° C., holding at temperature for 360 s. Then it is cooled to 40° C. Next, the mixture is inoculated with 0.01 wt % of bacterial culture F-DVS YoFlex® Creamy 1.0 (from the company CHR Hansen) and incubated in a warming cabinet at 37° C. until pH<4.6 is reached.

### (b) Placing the Acidified-Milk-Based Preparation on Pizza Dough

The preparation produced in a) optionally has further spices added (see Table 1 below) and is placed on pizza bases. Visual and sensory assessment of the preparation was performed in the unbaked and baked state of the pizza dough. The freezing/thawing stability of the sauce was also assessed, by
A) freezing a 50 g sample in a sample container at −18° C. On the next day it was thawed at refrigerator temperature (+4° C.) and then the appearance and whey separation were assessed.
B) 50 g of sauce was placed on pizza dough and was then frozen at −18° C. The appearance and structure were assessed before final baking.

The results are given in Tables 1 and 2.

The freezing/thawing stability of the pizza dough with the acidified-milk-based preparation according to the invention was assessed as follows:

1=very good stability
2=good stability
3=adequate stability
4=inadequate stability

TABLE 1
Preparations produced, on pizza dough (FTS = freezing/thawing stability)

| Ex. | Bacterial culture | Stabilization | Spices | Visual | FTS |
|---|---|---|---|---|---|
| A | 0.01% thermophilic | — | — | crumbly, broken | 4 |
| | YoFlex ® culture | | | | |
| B | 0.01% thermophilic | 3% | — | smooth | 1 |
| | YoFlex ® culture | HAMULSION | | | |
| | | RUK | | | |
| C | 0.01% thermophilic | 3% Novation | — | somewhat crumbly, | 2 |
| | YoFlex ® culture | Endura 3300 | | whey | |
| D | 0.01% thermophilic | 3% Novation | — | somewhat crumbly, | 2 |
| | YoFlex ® culture | Endura 0100 | | whey | |
| E | 0.01% thermophilic | 2% Novation | 3% spice | somewhat crumbly, | 2 |
| | YoFlex ® culture | Endura 0100 | mixture 1 | a little whey | |
| G | 0.01% thermophilic | 3% Novation | 3% spice | whey, partially | 2 |
| | YoFlex ® culture | Endura 3300 | mixture 1 | gelled | |
| H | 0.01% thermophilic | 3% Novation | 4% spice | whey, partially | 1 |
| | YoFlex ® culture | Endura 3300 | mixture 1 | gelled | |
| I | 0.01% thermophilic | 3% Novation | 4% spice | whey, partially | 1 |
| | YoFlex ® culture | Endura 3300 | mixture 2 | gelled | |
| J | 0.01% thermophilic | 3% Novation | 5% cheese | whey, gelled to | 1 |
| | YoFlex ® culture | Endura 3300 | powder Creemo | small parts | |
| | | | 470006 | | |
| K | 0.01% thermophilic | 3% Novation | 5% cheese | whey, crumbly | 2 |
| | YoFlex ® culture | Endura 3300 | powder Creemo | | |
| | | | 4700644 | | |
| L | 0.01% thermophilic | 2% Novation | — | whey, partially | 1 |
| | YoFlex ® culture | Endura 0100 | | gelled | |
| M | 0.01% thermophilic | 2% Novation | 5% cheese | whey, partially | 1 |
| | YoFlex ® culture | Endura 0100 | powder Creemo | gelled | |
| | | | 4700522 | | |
| N | 0.01% thermophilic | 2% Novation | 5% cheese | whey, initial gelling | 1 |
| | YoFlex ® culture | Endura 0100 | powder Creemo | | |
| | | | 4700644 | | |

Spice mixture 1: water, spices, sea salt, lemon juice (from lemon juice concentrate), thickening agent E415, onion granules, additional spices: garlic, pepper, parsnip

Spice mixture 2: based on 718 with onion powder (finer onions), higher proportion of garlic

Cheese powder Cremo 4700522 and cheese powder Cremo 4700644 from the company Kerry Ingredients & Flavours.

Novation Endura TM 0100 and Novation Endura TM 3300 from Ingredion.

Thermophilic YoFlex® cultures: F-DVS YoFlex® Mild 2.0 or F-DVS YoFlex® Creamy 1.0 from the company CHR Hansen.

### Sensory Assessment

The preparation was tasted before baking and after baking. The results are presented in Table 2.

TABLE 2
Sensory assessment of the sour milk based preparations produced, on pizza dough

| | Unbaked | | Baked on pizza | |
|---|---|---|---|---|
| Ex. | Visual | Mouthfeel | Visual | Taste and mouthfeel |
| A | smooth | little taste | inadequate | crumbly, dry, musty |
| B | smooth | very full pectin taste | very good | massive, solid, voluminous, dry |
| C | smooth | fresh, not musty | very good | massive, solid, voluminous |
| D | smooth | creamy, not musty | very good | massive, solid, voluminous |
| E | smooth | somewhat oniony, somewhat peppery | very good | somewhat oniony, somewhat peppery |
| G | smooth | pepper and onion discernible | very good | pepper and onion discernible |
| H | smooth | pepper and onion discernible | very good | pleasant onion and pepper taste |
| I | smooth | pepper and onion discernible | good | pepper and onion discernible |
| J | smooth | slight cheese taste | very good | slight cheese taste |
| K | smooth | Cheddar taste readily discernible | very good | Cheddar taste readily discernible |
| L | smooth | full, creamy | very good | voluminous |
| M | smooth | Emmental taste readily discernible | very good | Emmental taste readily discernible |
| N | smooth | Cheddar taste readily discernible | very good | Cheddar taste readily discernible |

### Example 2

### Pizza Formulations

2.1. Formulations with Sample L

| | | | | | Initial | Initial |
|---|---|---|---|---|---|---|
| | Sample | | Dosage | Target | weight of | weight of |
| Sample | No. | Designation | (%) | amount (g) | sample (g) | sauce (g) |
| PLAIN | L/0 | Pizza Sauce White | / | 1000 | / | 1000 |
| (without | | | | | | |
| additional | | | | | | |
| taste) | | | | | | |
| EXOTIC | | | | | | |
| Exotic | L/1 | Asia LC | 8 | 1000 | 80 | 920 |
| Asia | L/2 | fruity curry LC | 15 | 1000 | 150 | 850 |
| | L/3 | Thai LC/Chilli LC | 8 | 1000 | 80 | 920 |
| Exotic | L/4 | Pepper LC | 8 | 1000 | 80 | 920 |
| pungent/ | L/5 | Chilli LC | 8 | 1000 | 80 | 920 |
| spicy | L/6 | Pepper + lemon | 8 | 1000 | 80 | 920 |
| | L/7 | Pepper + lemon | 8 | 1000 | 80 | 920 |
| | | (more pungent) | | | | |
| | L/8 | Paprika, smoke-dried | 8 | 1000 | 80 | 920 |
| Exotic | L/9 | Chimichuri (dry) | 4 | 500 | 20 | 480 |
| South | L/10 | Guacamole | 8 | 500 | 40 | 460 |
| America | | | | | | |
| PIZZA, | L/11 | Spicy LC, onion | 3 | 500 | 15 | 485 |
| SPICY | | pepper | | | | |
| HERBS | L/12 | Spicy & Herbs LC | 3 | 500 | 15 | 485 |
| | L/13 | Spicy & Herbs LC | 3 | 500 | 15 | 485 |
| | L/14 | Chives Parsley | 6 | 500 | 30 | 470 |
| | | LC HF | | | | |
| | L/15 | Mediterranean | 6 | 500 | 30 | 470 |
| | | Herbs LC HF | | | | |

2.2. Formulations with Sample M

| | | | | | Initial | Initial |
|---|---|---|---|---|---|---|
| | Sample | | Dosage | Target | weight of | weight of |
| Sample | No. | Designation | (%) | amount (g) | sample (g) | sauce (g) |
| CHEESE | M/0 | Emmental Pizza | / | 1000 | / | 1000 |
| ONLY - | | Sauce White | | | | |
| EMMENTAL | | | | | | |
| EXOTIC | | | | | | |
| Exotic | M/1 | Asia LC | 8 | 500 | 40 | 460 |
| Asia | M/2 | fruity curry LC | 15 | 500 | 75 | 425 |
| | M/3 | Thai LC/Chilli LC | 8 | 500 | 40 | 460 |
| Exotic | M/4 | Pepper LC | 8 | 500 | 40 | 460 |
| pungent/ | M/5 | Chilli LC | 8 | 500 | 40 | 460 |
| spicy | M/6 | Pepper + lemon | 8 | 500 | 40 | 460 |
| | M/7 | Pepper + lemon | 8 | 500 | 40 | 460 |
| | | (more pungent) | | | | |
| | 52/8 | Paprika, smoke-dried | 8 | 500 | 40 | 460 |
| Exotic | M/9 | Chimichuri (dry) | 4 | 500 | 20 | 480 |
| South | M/10 | Guacamole | 8 | 500 | 40 | 460 |
| America | | | | | | |
| PIZZA, | M/11 | Spicy LC, onion | 3 | 1000 | 30 | 970 |
| SPICY | | pepper | | | | |
| HERBS | M/12 | Spicy & Herbs LC | 3 | 500 | 15 | 485 |
| | M/13 | Spicy & Herbs LC | 3 | 500 | 15 | 485 |
| | M/14 | Chives Parsley | 6 | 500 | 30 | 470 |
| | | LC HF | | | | |
| | M/15 | Mediterranean | 6 | 500 | 30 | 470 |
| | | Herbs LC HF | | | | |

2.3. Formulations with Sample N

| | | | | | Initial | Initial |
|---|---|---|---|---|---|---|
| | | | Dosage | Target | weight of | weight of |
| Sample | | Designation | (%) | amount (g) | sample (g) | sauce (g) |
| CHEESE | N/0 | Cheddar Pizza | / | 1000 | / | 1000 |
| ONLY - | | Sauce White | | | | |
| CHEDDAR | | | | | | |
| EXOTIC | | | | | | |
| Exotic Asia | N/1 | Asia LC | 8 | 500 | 40 | 460 |
| | N/2 | fruity curry LC | 15 | 500 | 75 | 425 |
| | N/3 | Thai LC/Chilli LC | 8 | 500 | 40 | 460 |
| Exotic | N/4 | Pepper LC | 8 | 500 | 40 | 460 |
| pungent/ | N/5 | Chilli LC | 8 | 500 | 40 | 460 |
| spicy | N/6 | Pepper + lemon | 8 | 500 | 40 | 460 |
| | N/7 | Pepper + lemon | 8 | 500 | 40 | 460 |
| | | (more pungent) | | | | |
| | N/8 | Paprika, smoke-dried | 8 | 500 | 40 | 460 |
| Exotic | N/9 | Chimichuri (dry) | 4 | 500 | 20 | 480 |
| South | N/10 | Guacamole | 8 | 500 | 40 | 460 |
| America | | | | | | |
| PIZZA, | N/11 | Spicy LC, onion | 3 | 1000 | 30 | 970 |
| SPICY | | pepper | | | | |
| HERBS | N/12 | Spicy & Herbs LC | 3 | 500 | 15 | 485 |
| | N/13 | Spicy & Herbs LC | 3 | 500 | 15 | 485 |
| | N/14 | Chives Parsley | 6 | 500 | 30 | 470 |
| | | LC HF | | | | |
| | N/15 | Mediterranean | 6 | 500 | 30 | 470 |
| | | Herbs LC HF | | | | |

### Example 3

### Acidified Milk Product as Dip or Spread

All the components in Table 3 are mixed together (>10° C.) and stirred to a homogeneous mass.

| | | Acidified milk | | | |
|---|---|---|---|---|---|
| | Low-fat | product according | | | |
| Sample | quark | to the invention | Herbs* | Water | Salt |
| O | 69 wt % | 29 wt % | 0.5 wt % | 0.8 wt % | 0.7 wt % |
| P | 55 wt % | 43.5 wt % | 0.3 wt % | 0.5 wt % | 0.7 wt % |

*Herbs: mixture of parsley, horseradish, onion, chives

1. Acidified milk product, comprising
(a) 30 to 80 wt % milk,
(b) 5 to 80 wt % fat component,
(c) 0.5 to 4 wt % starch and
(d) 0.001 to 0.1 wt % of mesophilic lactic acid bacteria and/or thermophilic lactic acid bacteria,
with the proviso that components (a) to (d) add up to 100 wt %.

2. The product according to claim 1, wherein the product additionally comprises taste-imparting substances that determine the general taste of the final composition, which is selected from spicy, cheesy, pungent, umami, strong, exotic, bitter, salty, sour and/or sweet.

3. The product according to claim 1, wherein the starch is modified and/or native starch and the fat component is either milk fat with a fat content from 10% to 45% or vegetable fat.

4. The product according to claim 1, wherein the total fat content of the product is from 0.1% to 45%, with the total fat content being made up of the fat content of the milk and of the fat component.

5. The product according to claim 1, wherein the product does not contain a tomato basic sauce.

6. The product according to claim 1, wherein, as optional component, it additionally contains other additives, which are selected from the group comprising buttermilk, aroma substances, salt, sugar, herbs, spices, garlic, onions, acidifying agents, stabilizers and antioxidants.

7. A sauce, covering sauce, spread or dip comprising the acidified milk product according to claim 1.

8. A preparation with good baking and freezing/thawing stability in or on frozen products comprising the acidified milk product according to claim 1.

9. A covering sauce for pizza comprising the acidified milk product according to claim 1.

10. The covering sauce according to claim 9, wherein the pizza is a frozen.

11. A method for improving the taste in the final composition selected from the group consisting of spicy, cheesy, pungent, umami, strong, exotic, bitter, salty, sour and/or sweet, comprising applying the acidified milk product according to claim 1.

12. The method according to claim 11, comprising applying the acidified milk product as a covering sauce on pizza to improve the taste.

13. Acidified milk base mass with improved taste properties, obtainable by
(i) stirring milk and cream and starch in a mixer, warming and homogenizing under pressure, and then heating,
(ii) inoculating the resultant mixture with lactic acid cultures and
(iii) incubating in a suitable temperature range until pH<4.6 is reached,
(iv) wherein the lactic acid cultures used are thermophilic lactic acid cultures and the resultant acidified milk base mass has a total fat content not exceeding 20%.

14. Method of production of frozen pizza, wherein in the first step
(i) the dough is prepared, and then
(ii) the acidified milk product according to claim 1 is applied on the prepared dough, and then
(iii) the dough with the acidified milk product is pre-baked in the baking oven, and then
(iv) optionally further ingredients are applied and
(v) it is quick-frozen.

15. Kit containing an acidified milk product according to claim 1 in packaged form and a previously prepared pizza dough, which just needs baking before eating.
